(19) United States
(12) Patent Application Publication
(10) Pub. No.: US 2003/0010777 A1
(43) Pub. Date: Jan. 16, 2003

(54) Food package

(76) Inventor: Mark C. Milgrom, Farmington Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 09/902,522

(22) Filed: Jul. 10, 2001

(51) Int. Cl. H05B 6/80

(52) U.S. Cl. 219/725; 219/734

(57) ABSTRACT

A disposable food container for storing, microwave heating, and serving of food items includes a rigid base having a horizontal surface and a concave surface depending therefrom and in combination define a central cavity therein. The base further has at least two legs depending from a lower side of the horizontal surface, the legs extending below a depth of the concave surface. An upper side of the horizontal surface defines at least two depressions therein, each depression in vertical alignment with a bottom of one of the two legs wherein the depressions are sufficient size to receive a bottom of a like leg of a like container. A receptacle is received in the cavity and affixed to the rigid base. The receptacle has a rim extending above the horizontal surface and further includes a removable barrier affixed to the rim. The barrier and the receptacle define an enclosed space for retaining food product therein.

### BACKGROUND OF THE INVENTION

This invention relates to a packaging container for prepared food products.

More specifically, this invention relates to a packaging container which also serves as the cooking and eating utensil for the prepared food product.

Food product containers have evolved with the advent of the microwave oven and the desire for quick and easy food preparation. The sale of prepared foods that are microwavable has required a change in the type of packaging that has been used in the past. In fact, prepared food packaging is now designed to specifically meet the functional requirements of the microwave oven for the end consumer.

Examples of this type of packaging can be found in U.S. Pat. No. 5,178,294 to Hill et al, U.S. Pat. No. 5,345,069 to Grindrod, and U.S. Pat. No. 5,709,308 to Gics. These concepts, although microwavable, are not functional as an eating utensil.

The prior art, however, does not provide food product packaging that allows food to be sealed in an aseptic container that functions as both a cooking utensil and an eating utensil. In addition, this type of multifunctional packaging would require the means for stacking the packaging for both storage and shipping.

### SUMMARY OF THE INVENTION AND ADVANTAGES

One aspect of the present invention is a disposable food container for storing, microwave heating, and serving of food items. The container includes a rigid base having a horizontal surface and a concave surface depending therefrom and in combination define a central cavity therein. The base further includes at least two legs depending from a lower side of the horizontal surface, the legs extending below a depth of the concave surface. An upper side of the horizontal surface defines at least two depressions therein, each depression in vertical alignment with a bottom of one of the two legs wherein the depressions are sufficient size to receive a bottom of a like leg of a like container. A receptacle is received in the cavity and affixed to the rigid base. The receptacle has a rim extending above the horizontal surface and further includes a removable barrier affixed to the rim. The barrier and the receptacle define an enclosed space for retaining food product therein.

These and other advantages of the invention will be further understood and appreciated by those skilled in the art by reference to the following written specification, claims and appended drawings.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a front elevational view of the subject concept;

FIG. 2 is an overhead view of the subject concept showing a single receptacle;

FIG. 3 is a sectional view along line 3-3 as seen in FIG. 2; and

FIG. 4 is an overhead view of an alternate embodiment of the subject concept showing two receptacles.

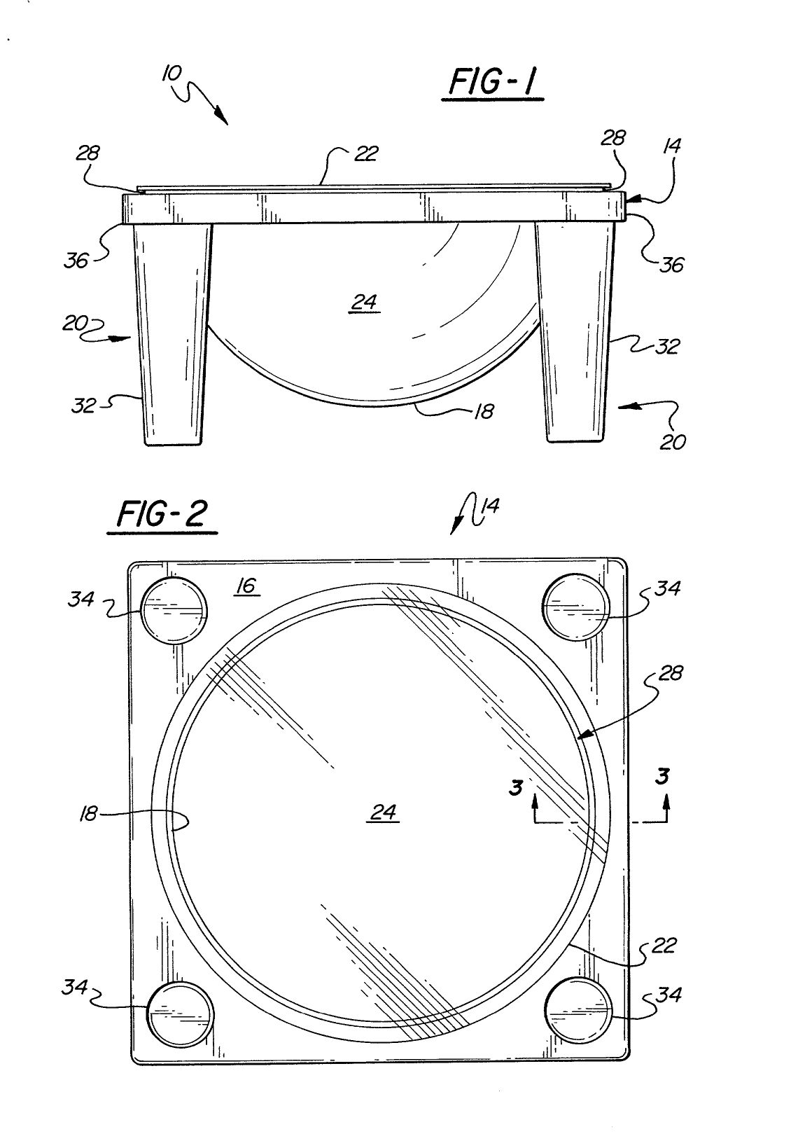

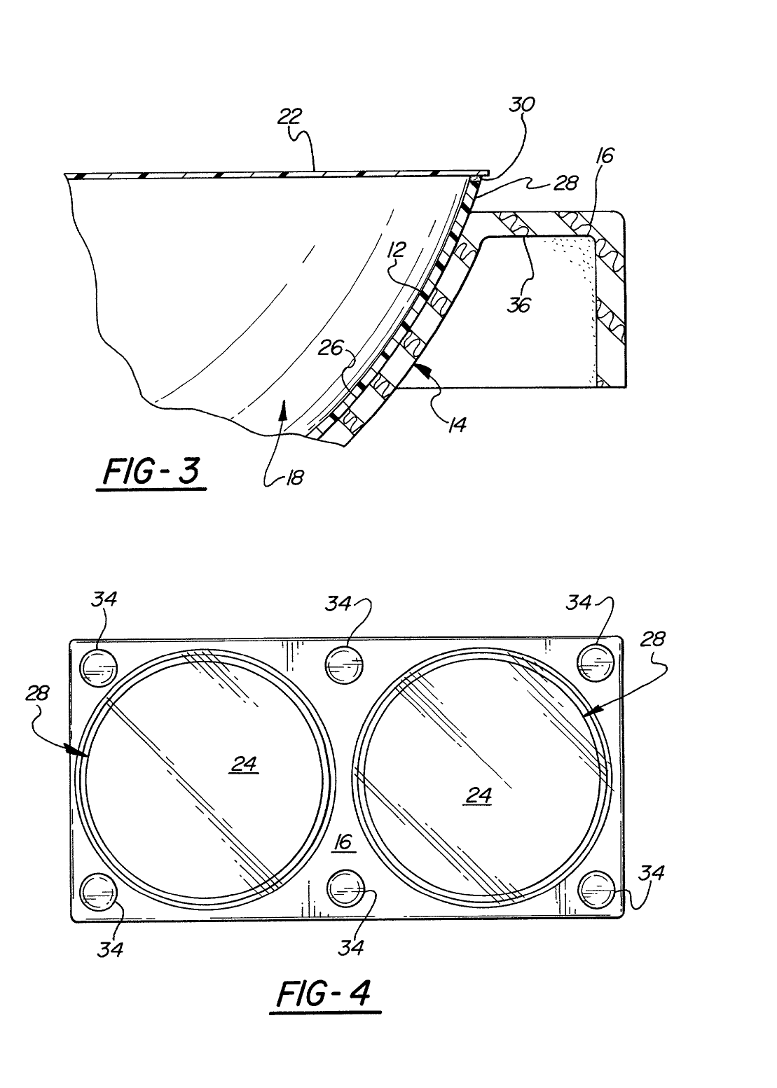

### DETAILED DESCRIPTION OF THE PREFERRED EMBODIMENT

Referring to the Figures, wherein like numerals indicate like or corresponding parts throughout the several views, a food product container is generally shown at 10. The container 10 includes at least one food receptacle 12 and a rigid base 14 forming a horizontal surface 16. The base 14 includes at least one cavity 18 in the surface 16 for receiving the receptacle 12 and a stand 20 for supporting the container 10. The stand 20 is integrally formed with the surface 16. The cavity 18 defines a concave inner surface 26 for supporting the receptacle 12. The receptacle 12 is laminated, glued, or otherwise affixed to the inner surface 26 for fixedly attaching the receptacle 12 to the base 14. The container 10 further includes a removable barrier 22 for retaining the food product within the receptacle 12.

The receptacle 12 is made of a microwavable material for heating the food product stored therein. For example, the container 10 could be removed from a freezer and be placed directly into a microwave for heating. Additionally, the food product can be of the type that does not require heating such as baby food or the like. The barrier 22 forms an enclosed, aseptic chamber 24 with the receptacle 12 that is air tight for retaining the food product therein as will be discussed further hereinbelow.

The base 14 is made of an insulating material that is immune to microwaves for insulating the receptacle. Therefore, the base 14 will not efficiently conduct heat and therefore is contemplated to comprise, for example, polystyrene, paperboard, or a functional equivalent. In addition, the base 14 will be of sufficient rigidity to support the entire container 10 when gripped by only one edge.

The receptacle 12 includes a rim 28 and the barrier 22 is affixed to the rim 28 by applying an adhesive between rim 28 and barrier 22 or by fusing barrier 22 directly to rim 28. The rim 28 extends above the horizontal surface 16 for preventing the food product stored therein from spilling onto the horizontal surface 16. Thus, the container 10 can be slightly tipped and the food product will not spill out onto the horizontal surface 16. It should be appreciated that due to the low center of gravity of the receptacle 12, the container 10 will be difficult to tip. The barrier 22 includes a separating device 30 disposed upon the rim 28 with the barrier 22 for separating the barrier 22 from the receptacle 12. For example, the separating device 30 can take the form of a pull string, a pull tab, or a functional equivalent. The barrier 22 can be scored proximate to and interior of rim 28 permitting the separation of a central portion of barrier 22 from a peripheral portion bonded to rim 28. An additional alternative for removing the barrier 22 includes pulling on a portion of barrier 22 overhanging the rim 28 to overcome the adhesive bond between the barrier 22 and rim28. Depending upon the type of food product disposed within the receptacle 12, the barrier 22 may or may not require removal prior to the container 10 being placed in a microwave oven for heating.

The barrier 22 when bonded or fused to rim 28 forms an aseptic enclosure with the receptacle 12 for aseptically storing food product therein. Those skilled in the art of food packaging know that an aseptic package can include a multi-layered lamination of plastic, aluminum, and paper. This packaging provides the ability to store food products for extended periods of time without requiring preservatives, or even refrigeration. A popular, and widely used example of this type of packaging is the drink box. The contemplated receptacle 12 forms the aseptic packaging into a bowl for both heating and eating out of. Aseptic packaging may not, however, be required for each of the uses proposed for the subject container 10. In fact, many food products will not require aseptic packaging.

The stand 20 includes at least two legs 32 for supporting the container 10. For example, two wide legs 32 can support the container 10, or any number of narrower legs 32 can support the container 10 including three legs 32, four legs 32, or more as might be required. It is contemplated that one continuous leg 32 would also sufficiently support the container 10.

The legs 32 are sufficiently rigid to provide the ability to stack multiple containers 10 for packaging and shipping. Thus, the horizontal surface 16 includes depressions 34 above and in alignment with the legs 32 for stacking the containers 10. The depressions 34 provide the means for securely stacking several layers of containers 10 by preventing the legs 32 from sliding on the horizontal surface 16.

The horizontal surface 16 includes an overhang 36 surrounding the horizontal surface 16 for gripping the container 10. The overhang 36 functions as a handle for manually gripping the container 10. The container 10 may be gripped by the base 14 (overhang 36) for removal from a microwave even when the receptacle 12 is hot, due to the insulating properties of the base 14 material. The rigidity of the base 14 allows the container 10 to be removed when gripped by one side or corner and not cause the food product to spill from the receptacle 12 due to the base 14 flexing. In addition, the overhang 36, and even the horizontal surface 16 provide space for adding labeling meeting advertising needs and federal regulatory requirements.

As shown in FIG. 2, the container 10 includes one receptacle 12 and the base 14 includes one cavity 18 for receiving the receptacle 12. An alternative is shown in FIG. 4 where the container 10 includes two receptacles 12 for retaining two food products and the base 14 includes two cavities 18 for receiving the receptacles 12. For a further alternative, the container 10 might include several receptacles 12, each having a different food product for providing an entire meal.

In use, the container 10 would be removed from storage, i.e. a freezer, refrigerator, pantry etc. and placed in a microwave, if desired, for heating. Some food products, such as baby food might not require any heating. The barrier 22 can be removed and the heated food product eaten directly from the container 10. However, depending on the food product, disposed within the receptacle 12, the barrier 22 may or may not require removal prior to being placed into a microwave for heating. When the food product has been consumed, the container 10 can be disposed of.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described. For example, the receptacle 12 and the barrier 22 could be formed as a unit for receipt of a food product. The food product could be introduced to the unit and the receptacle 12 and the barrier 22 sealed after or even before aseptic treatment of the food product. The packaged food product could then be laminated to the concave surface 26. Alternatively, the receptacle 12 could be laminated to the surface 26 and then have food product introduced and subsequently, the barrier 22 applied.

In the foregoing description, those skilled in the art will readily appreciate that modifications may be made to the invention without departing from the concepts disclosed herein. Such modifications are to be considered as included in the following claims, unless the claims by their language expressly state otherwise.

I claim:

1. A disposable food container for storing, microwave heating, and serving food items, said container comprising:
a rigid base having a horizontal surface including a concave surface depending therefrom, said horizontal surface and said concave surface defining a central cavity therein, said base further including at least two legs depending from a lower side of said horizontal surface, said at least two legs extending below a depth of said concave surface, and wherein an upper side of said horizontal surface defines at least two depressions therein, each of said depressions in vertical alignment with a bottom of one of said at least two legs, said depressions of sufficient size to receive a bottom of a like leg of a like container;
a receptacle received in said cavity and affixed to said rigid base, said receptacle having a rim extending above said horizontal surface and further including a removable barrier affixed to said rim, said barrier and said receptacle defining an enclosed space for retaining food product therein.

2. A container according to claim 1 wherein said receptacle is formed from a material conducive for microwave heating of the food product stored therein.

3. A container according to claim 1 wherein said base is formed from a materiel immune to microwaves for insulating said receptacle.

4. A container according to claim 3 wherein said horizontal surface includes a rim extending downwardly from a periphery of said horizontal surface.

5. A container according to claim 1 wherein said barrier includes a separating device proximate to said rim for separating said barrier from said receptacle.

6. A container according to claim 5 wherein said barrier is bonded to said rim and said separating device comprises a barrier portion overhanging said rim for a user to pull to debond said barrier from said rim.

7. A container according to claim 5 wherein said separating device comprises a scoring to separate a predefined central portion of said barrier from a peripheral portion bonded to said rim.

8. A container according to claim 5 wherein said barrier in combination with said receptacle forms an aseptic enclosure aseptically storing food product therein.

9. A container according to claim 1 wherein said container includes two receptacles for retaining two food products and said base defines two cavities for receiving said receptacles.
